(19) United States
(12) Patent Application Publication
(10) Pub. No.: US 2018/0163559 A1
(43) Pub. Date: Jun. 14, 2018

(54) CONDUIT BOX ASSEMBLY SYSTEMS AND METHODS

(71) Applicant: General Electric Company, Schenectady, NY (US)

(72) Inventor: Edgar Ramirez Rosas, Queretaro (MX)

(21) Appl. No.: 15/379,096

(22) Filed: Dec. 14, 2016

(51) Int. Cl. F01D 17/14; H02G 3/08

(52) U.S. Cl. CPC F01D 17/145; F05D 2220/32; H02G 3/083; H02G 3/088

(57) ABSTRACT

A system includes a conduit box assembly configured to be rated as an explosion-proof (Ex d) rated enclosure. The conduit box assembly includes a housing configured to support an electrical device. The housing includes multiple openings. The conduit box assembly also includes a first cable gland and a conduit union. The first cable gland is positioned at a first opening in the housing to enable a cable to extend into the housing to the electrical device. The conduit union is positioned at a second opening in the housing and configured to couple to a component of a gas turbine system. The conduit union enables the cable to extend from the electrical device out of the housing to couple to the component.

### BACKGROUND

The subject matter disclosed herein relates to gas turbine engines, and more particularly to systems and methods for installing simple apparatus components that are not rated for an explosive atmosphere into a Zone 2 hazardous area and/or a T3 area.

Gas turbine systems generally include a compressor, a combustor, and a turbine. The combustor combusts a mixture of compressed air and fuel to produce hot combustion gases directed to the turbine to produce work, such as to drive an electrical generator. Gas turbine systems generate heat and combustible gases, and thus, certain electrical devices, such as varistors and resistors, are positioned remotely from the components they are coupled to in the gas turbine system.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a conduit box assembly configured to be rated as an explosion-proof (Ex d) rated enclosure. The conduit box assembly includes a housing configured to support an electrical device. The housing includes multiple openings. The conduit box assembly also includes a first cable gland and a conduit union. The first cable gland is positioned at a first opening in the housing to enable a cable to extend into the housing to the electrical device. The conduit union is positioned at a second opening in the housing and configured to couple to a component of a gas turbine system. The conduit union enables the cable to extend from the electrical device out of the housing to couple to the component.

In a second embodiment, a system includes a component of a gas turbine system and a conduit box assembly. The conduit box assembly includes a housing and an electrical device positioned within the housing. The conduit box assembly also includes a first cable gland and a conduit union. The first cable gland is positioned at a first opening formed in the housing. The conduit union is positioned at a second opening formed in the housing and is configured to couple to and to contact the component. The system also includes a first cable extending through the first cable gland into the housing to couple to the electrical device and extending from the housing through the conduit union to couple to the component.

In a third embodiment, a method includes positioning an electrical device within a housing of a conduit box assembly, coupling a cable gland to the housing at a first opening in the housing, coupling a conduit union to the housing at a second opening in the housing, positioning a cable through the cable gland to couple to the electrical device and extending the cable through the conduit union, and positioning the conduit box assembly within a Zone 2 region, a T3 region, or a region that is both a Zone 2 and a T3 region of a gas turbine system.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a gas turbine system having multiple conduit box assemblies coupled to components of the gas turbine system;

FIG. 2 is a schematic diagram of an embodiment of a conduit box assembly supporting an electrical device coupled to a component of the gas turbine system of FIG. 1 via a cable;

FIG. 3 is a schematic diagram of an embodiment of a conduit box assembly supporting an electrical device coupled to a component of the gas turbine engine system of FIG. 1 via multiple cables;

FIG. 4 is a schematic diagram of an embodiment of a conduit box assembly supporting a varistor coupled to a solenoid valve that may be used in the gas turbine system of FIG. 1 via multiple cables;

FIG. 5 is a top view of an embodiment of a conduit box assembly that may be used in the gas turbine system of FIG. 1;

FIG. 6 is a perspective view of an embodiment of the conduit box assembly of FIG. 5;

FIG. 7 is cross-sectional perspective view of an embodiment of the conduit box assembly of FIG. 5; and

FIG. 8 is a flow diagram of a method of coupling an electrical device to a component in a Zone 2/T3 area of a gas turbine system using a conduit box assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments provide systems and methods for the housing and positioning of electrical devices (e.g., simple apparatus devices or simple electrical apparatuses) that are not rated for use in hazardous or explosive atmospheres throughout gas turbine systems. Components of gas turbine systems may be located within a Zone 2 and/or T3 area. The disclosed embodiments include a conduit box assembly rated for hazardous areas that enables electrical devices to be coupled to components (e.g., solenoid valves, sensors, or the like) of the gas turbine system and to be positioned within the Zone 2 and/or T3 area. The electrical devices may be electrical components, such as varistors or resistors, used to protect against overvoltage, although it should be understood that the disclosed systems and methods may be used with any of a variety of electrical devices.

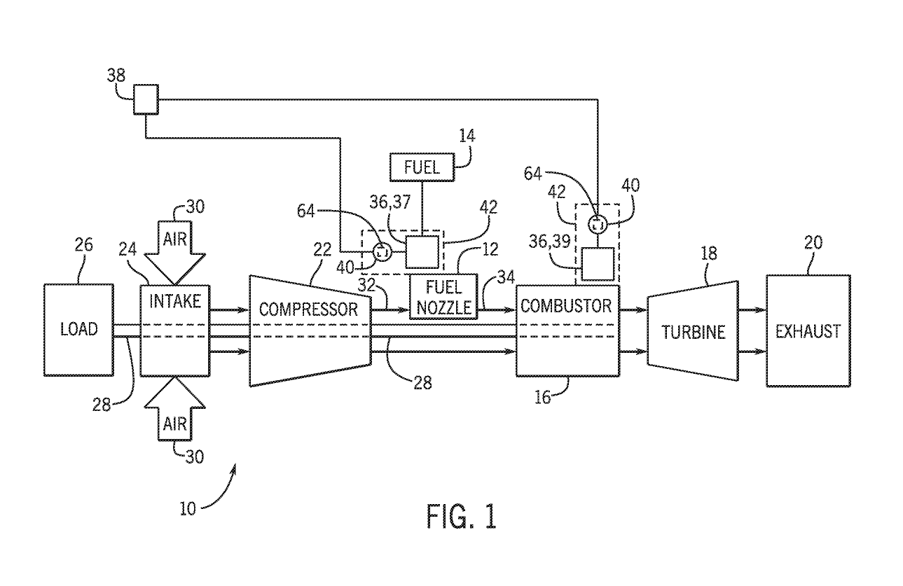

Turning now to the drawings, FIG. 1 is a block diagram of an embodiment of a gas turbine system 10. The diagram includes a fuel nozzle 12, a fuel 14, and a combustor 16. As depicted, the fuel 14 (e.g., a liquid fuel and/or gas fuel, such as natural gas) is routed to the turbine system 10 through the fuel nozzle 12 into the combustor 16. The combustor 16 ignites and combusts the air-fuel mixture 34, and then passes hot pressurized exhaust gas into a turbine 18. The exhaust gas passes through turbine blades of a turbine rotor in the turbine 18, thereby driving the turbine 18 to rotate. The coupling between blades in the turbine 18 and a shaft 28 will cause the rotation of the shaft 28, which is also coupled to several components (e.g., a compressor 22, a load 26) throughout the turbine system 10. Eventually, the exhaust gases of the combustion process may exit the turbine system 10 via an exhaust outlet 20.

In an embodiment of the turbine system 10, compressor vanes or blades are included as components of the compressor 22. Blades within the compressor 22 may be coupled to the shaft 28, and will rotate as the shaft 28 is driven to rotate by the turbine 18. The compressor 22 may intake air 30 to the turbine system 10 via an air intake 24. Further, the shaft 28 may be coupled to the load 26, which may be powered via rotation of the shaft 28. As appreciated, the load 26 may be any suitable device that may generate power via the rotational output of the turbine system 10, such as a power generation plant or an external mechanical load. For example, the load 26 may include an electrical generator, a propeller of an airplane, and so forth. The air intake 24 draws air 30 into the turbine system 10 via a suitable mechanism, such as a cold air intake, for subsequent mixture of air 30 with fuel 14 via the fuel nozzle 12. Air 30 taken in by the turbine system 10 may be fed and compressed into pressurized air 32 by rotating blades within compressor 22. The pressurized air 32 may then be fed into one or more fuel nozzles 12. Fuel nozzles 12 may then mix the pressurized air 32 and fuel 14, to produce a suitable air-fuel mixture 34 for combustion, e.g., a combustion that causes the fuel 14 to more completely burn, so as not to waste fuel 14 or cause excess emissions in the exhaust gases.

The turbine system 10 may include one or more components 36, such as one or more valves, actuators, sensors, switches, or any combination thereof. For example, the component 36 may include a solenoid valve configured to adjust a fluid flow by moving between an open position and a closed position. The one or more components 36 may include any other type of valve, for example, spool, gate, ball, check, proportional, or servo valves, or other various flow control devices. The one or more components 36 also may include one or more sensors, such as position sensors, pressure sensors, temperature sensors, vibration sensors, clearance sensors, leakage sensors, fluid composition sensors, emissions sensors, flame sensors, current sensors, voltage sensors, or any combination thereof. The one or more components 36 also may include various switches and actuators, such as electrical, mechanical, pneumatic, and/or hydraulic switches and actuators. The components 36 may be distributed at various locations about the turbine system 10. For example, in the illustrated embodiment, a first component 36, 37 may be a solenoid valve configured to adjust the flow of fuel 14 into the fuel nozzle 12, and a second component 36, 39 may be a pressure sensor configured to measure a pressure within the combustor 16. The one or more components 36 may be controlled by a controller 38 (e.g., electronic controller) which may be positioned remote from the turbine system 10. As described below, an electrical device 64, such as a varistor, resistor, or resistor assembly, may be provided to protect against overvoltage to the component 36. As shown, the electrical device 64 is housed in a conduit box assembly 40 that enables the electrical device 64 to be positioned in a Zone 2 hazardous area adjacent to the component 36 to which it is coupled.

Together, the conduit box assembly 40, the electrical device 64, and/or the component 36 may form a system 42 (e.g., an electrical system). The conduit box assembly 40 may be configured to be positioned at any location about the gas turbine system 10, including within a Zone 2 and/or T3 area about turbine system 10. In certain embodiments, the conduit box assembly 40 is configured to be an explosion-proof (Ex d) enclosure for use in a Zone 2 area within turbine system 10. Zone ratings may generally define the probability of a material, such as gas or dust, being present in sufficient quantities to produce an explosion or ignitable mixtures. In this manner, Zone ratings may be generally associated with the likelihood of an explosion. A Zone 2 rating indicates that there may be ignitable concentrations of flammable gases or vapors that are not likely to occur under normal operating conditions, but may be present for a short period of time. In a Zone 2 area, equipment shall be rated and should be provided in an explosion-proof (Ex d) rated enclosure, which may generally be configured to withstand (e.g., contain) an explosive gas or vapor within the enclosure, withstand the pressure developed during an internal explosion and prevent transmission of the explosion, and/or block the ignition of an explosive gas or vapor that may surround the enclosure.

Temperature class ratings may be generally based on a maximum surface temperature of electrical equipment in an area such that a surrounding explosive gas or vapor will not be ignited thereby. The ignition temperature relates to a minimum temperature on the surface of electrical equipment at which an explosive atmosphere will ignite, in the absence of a spark or flame. A T3 temperature class rating may correspond to a maximum surface temperature of 200° C. (i.e., 392° F.). Thus, to qualify for a T3 temperature class rating, no exposed surface may have a surface temperature above 200° C. The housing 50 of conduit box assembly 40 may be configured to maintain its internal temperature below approximately 200° C., and thus, may be used to house the electrical device 64 in a T3, or lower temperature class, area of the turbine system 10. It should be understood that the conduit box assembly 40 may be utilized within regions of various chemical and thermal characteristics within turbine system 10.

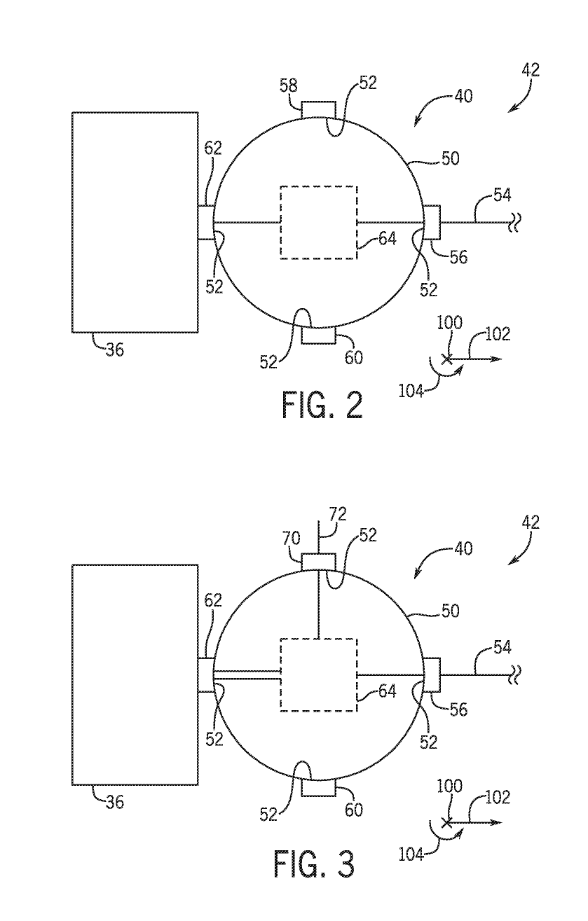

FIG. 2 is a schematic diagram of an embodiment of the system 42 of FIG. 1. As shown, the conduit box assembly 40 supports the electrical device 64 within a housing 50, which is coupled to the component 36 of turbine system 10 via a cable 54 (e.g., electrical cable). To facilitate discussion, the conduit box assembly 40 and its components may be described with reference to an axial axis or direction 100, a radial axis or direction 102, and a circumferential axis or direction 104. The electrical device 64 may be a varistor, a resistor, a resistor assembly, or any other electrical device (e.g., simple apparatus) that may be used by the component 36 or electrical circuit for proper operation. The housing 50 of the conduit box assembly 40 may contain multiple openings 52. As shown, four openings 52 are spaced circumferentially 104 (e.g., evenly spaced) around the housing 50 of conduit box assembly 40. However, in some embodiments, of the housing 50 may include any number (e.g., 1, 2, 3, 4, 5, 6, 7, 8, or more) of openings 52 in other arrangements around the housing 50.

In the illustrated embodiment, the cable 54 enters into the conduit box assembly 40 through a cable gland 56 (e.g., a cable connector or fitting) and connects to the electrical device 64 inside the housing 50. The cable 54 then exits the housing 50 through a conduit union 62 (e.g., a cable connector or fitting). To facilitate discussion, the cable 54 is referred to as one structure; however, it should be understood that the cable 54 may include multiple conductors, including various conductors electrically insulated from one another and multiple conductors electrically coupled to one another (e.g., via a terminal block). As shown, the conduit box assembly 40 is positioned adjacent to the component 36, and the conduit union 62 connects (e.g., directly contacts and/or connects) the housing 50 of the conduit box assembly 40 to the component 36 (e.g., a frame or housing of the component 36). The cable gland 56 and the conduit union 62 are connected to the housing 50 at respective openings 52. As illustrated, the cable gland 56 and the conduit union 62 may be positioned across from each other along the radial axis 102 on the housing 50 of the conduit box assembly 40 (e.g., on opposite sides of the housing 50). In some embodiments, the cable gland 56 and the conduit union 62 may be positioned at openings 52 in the housing 50 in a variety of orientations relative to one another.

In certain embodiments, openings 52 that are not connected to the cable gland 56 or the conduit union 62 may be connected to other conduit fittings. For example, one opening 52 in the housing 50 may be connected to or support a drain 60 (e.g., breather drains), which may be used to minimize moisture build up within the conduit box assembly 40, while maintaining the integrity (e.g., Ex d characteristics) of the conduit box assembly 40. The drain 60 may be positioned at any of the multiple openings 52 around the housing 50 of the conduit box assembly 40. In some embodiments, one opening 52 in the housing 50 may be connected to or support a stopper plug 58 (e.g., seal). The stopper plug 58 may be used to seal any unused openings of the multiple openings 52 in the housing 50 in order to maintain the integrity of the conduit box assembly 40. The cable gland 56, the conduit union 62, the drain 60, the stopper plug 58, or any other conduit fittings may or may not be included in certain embodiments of the conduit box assembly 40, and each may be positioned at any of the openings of the multiple openings 52 around housing 50. As noted above, the conduit box assembly 40 may be positioned adjacent to the component 36. The conduit union 62 connection between the conduit box assembly 40 and the component 36 may be positioned at any location about component 36 suitable for obtaining the desired coupling of the electrical device 64 and the component 36.

The conduit box assembly 40 may be utilized with a variety of components 36 of the turbine system 10, and may include multiple cable glands (e.g., 2, 3, 4, 5, or more) that provide for the entry of multiple cables (e.g., 2, 3, 4, 5, or more). FIG. 3 illustrates an embodiment of the system 42 having two cable glands 56, 70 connected to the housing 50. As shown, the first cable 54 enters the conduit box assembly 40 through the first cable gland 56, enabling connection to the electrical device 64 inside the housing 50 and further connection to the component 36 through the conduit union 62. In the illustrated embodiment, a second cable gland 70 (e.g., cable connector or fitting) may be connected to the housing 50 at one of the multiple openings 52. FIG. 3 shows the first cable gland 56 and the second cable gland 70 positioned at respective openings 52 that are oriented at a 90 degree angle relative to one another. However, in embodiments where there are multiple cable glands connected to the housing 50 of the conduit box assembly 40, the multiple cable glands may be positioned at any of the multiple openings 52 and at any positions relative to one another and the conduit union 62. As shown, a second cable 72 (e.g., electrical cable) enters the housing 50 of the conduit box assembly 40 through the second cable gland 70, enabling connection to the electrical device 64, or to another electrical device 64, inside the housing 50 and/or further connection to the component 36 through the conduit union 62. Thus, the conduit union 62 may be configured to enable multiple cables to exit the housing 50 of the conduit box assembly 40 and to enter into the component 36 via a single conduit union 62.

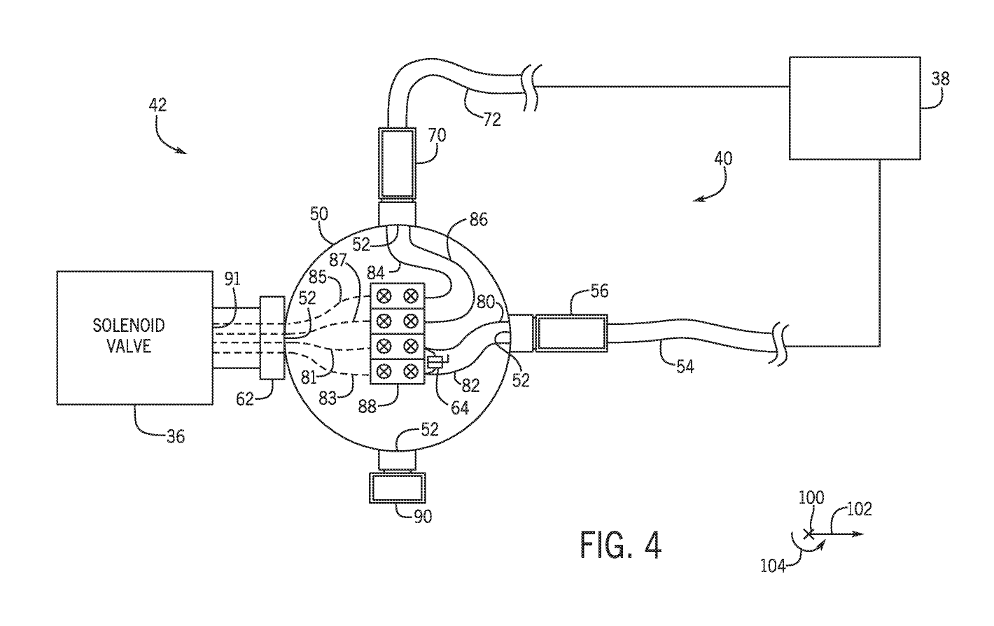

FIG. 4 illustrates an embodiment of conduit box assembly 40 that may be utilized when the component 36 is a solenoid valve of the turbine system 10. However, the illustrated conduit box assembly 40 may be utilized with various components 36, such as various valves, actuators, switches, and sensors, of the turbine system 10. In the illustrated embodiment, the solenoid valve 36 and the conduit box assembly 40 may be configured for use in a Zone 2 and/or T3 area of the turbine system 10. As shown, the conduit box assembly 40 is positioned adjacent to the solenoid valve 36. The first cable 54 may extend from the controller 38 (e.g., electronic controller having a processor and memory) and may provide power for the solenoid valve 36. As shown, the first cable 54 enters the housing 50 of the conduit box assembly 40 through the first cable gland 56, which is connected to one of the multiple openings 52 in the housing 50 of conduit box assembly 40. The second cable 72 may also extend from the controller 38 and may be used to control a sensor (e.g., a position sensor or switch) of the solenoid valve 36, which may be actuated when the solenoid valve 36 is energized and generates a signal indicative of whether the solenoid valve 36 is in the open or closed position. As shown, the second cable 72 enters the housing 50 of the conduit box assembly 40 through the second cable gland 70, which is connected to one of the multiple openings 52 in the housing 50. Each of the first cable 54 and the second cable 72 may include multiple conductors (e.g., electrical conductors configured to conduct electrical current). As shown, the first cable 54 includes a first conductor 80 and a second conductor 82, and the second cable 72 includes a first conductor 84 and a second conductor 86. In the illustrated embodiment, the first conductor 80 and the second conductor 82 of the first cable 54 are electrically connected via a terminal block 88 (e.g., terminal strip that is not rated for use in a hazardous area) and the electrical device 64 to a first valve conductor 81 and a second valve conductor 83 of the solenoid valve 36. In some embodiments, the electrical device 64 may be a varistor used to apply an electrical resistance, which varies with the applied voltage, to the current running through the first cable 54. The first conductor 80 and the second conductor 82 of first cable 54 are coupled to contacts (e.g., electrical contacts) of the terminal strip 88 and the electrical device 64 and exit the housing 50 of the conduit box assembly 40 through the conduit union 62, which connects the conduit box assembly 40 to the solenoid valve 36. In the illustrated embodiment, the first conductor 84 and the second conductor 86 of the second cable 72 are electrically connected via the terminal block 88 to a first sensor conductor 85 and a second sensor conductor 87 of the solenoid valve 36. In the illustrated embodiment, the first conductor 84 and the second conductor 86 of the second cable 72 are coupled to contacts (e.g. electrical contacts) of the terminal strip 88 and exit the housing 50 of the conduit box assembly 40 through the conduit union 62, which connects the housing 50 of the conduit box assembly 40 to the solenoid valve 36. The conduit union 62 may be configured to facilitate passage of multiple cables and/or multiple conductors into the component 36 through a single conduit union 62, a single opening 52 of the housing 52, and/or a single opening 91 of the component 36 (e.g., in the frame of the component 36). As discussed above, any openings 52 in the housing 50 not being used for entry of cables into the housing 50 of the conduit box assembly 40 may be connected to another conduit fitting 90. In the illustrated embodiment, the conduit fitting 90 may be a drain or a stopper plug, for example.

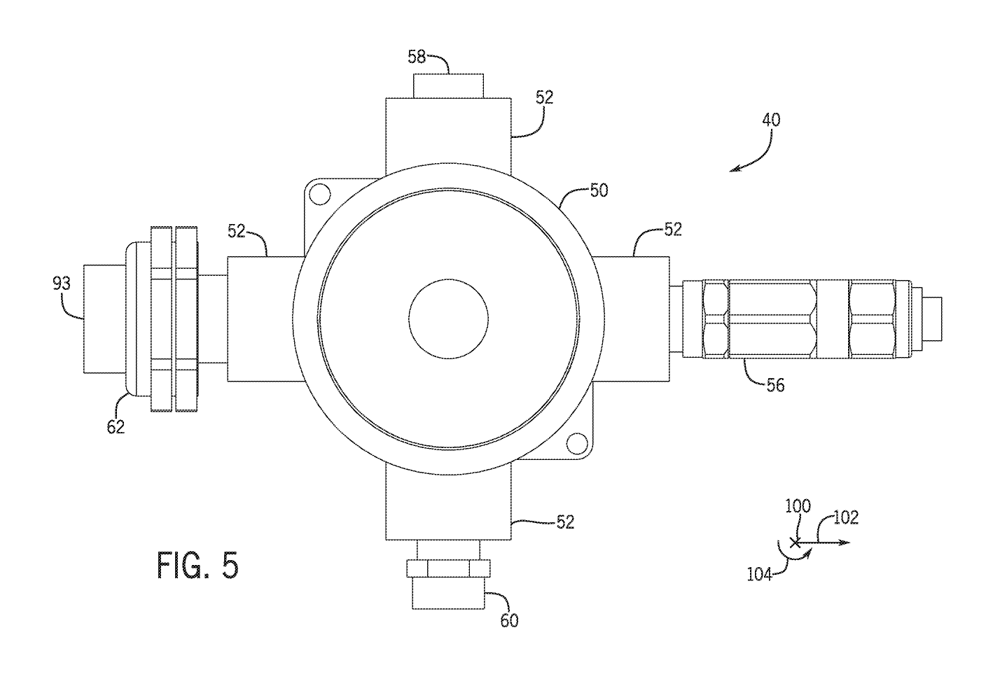

FIG. 5 illustrates a top view of an embodiment of the conduit box assembly 40 having connected the cable gland 56, the drain 60, the conduit union 62, and the stopper plug 58. The conduit box assembly 40, including the housing 50 and all conduit fittings (e.g., the cable glands 56, 70, the drain 60, the stopper plug 58, the conduit union 62), may be individually configured to be explosion-proof and to be located in any Zone 2 and/or T3 area of turbine system 10. The cables used may be configured to be explosion-proof and may enable complete explosion-proof (Exd) protection along with conduit box assembly 40. The cables may contain a compound filling configured to protect against propagation in the case of an explosion. The housing 50 of the conduit box assembly 40 may be a hollow enclosure configured to house or support an electrical device, and may be protective against exterior explosion, as well as protective against ignition of ignitable materials in the area. The housing 50 may have multiple openings 52 for connection to a variety of conduit fittings (e.g., the cable glands 56, 70, the drain 60, the stopper plug 58, the conduit union 62). In the illustrated embodiment, the housing 50 has four openings 52 for connections to conduit fittings, which are spaced circumferentially 104 around the housing 50. In some embodiments, the openings 52 may be spaced in a variety of configurations about the housing 50.

As shown, the cable gland 56 may be connected to the housing 50 of the conduit box assembly 40. The cable gland 56 may have an annular structure providing for the passage of a cable (e.g., the cable 54) into the housing 50 of the conduit box assembly 40. The cable gland 56 may be configured to provide an inner flame-proof seal and an outer environmental seal to protect against explosion and be explosion-proof (Ex d) rated for use in any Zone 2 and/or T3 area of turbine system 10. In the illustrated embodiment, one cable gland 56 is fitted to the housing 50 of the conduit box assembly 40 directly across from the conduit union 62 along a radial axis 102. In some embodiments, one or more cable glands may be fitted to the conduit box assembly 40 in a variety of configurations relative to each other and the conduit union 62.

As shown, the conduit union 62 may be connected to the housing 50 of the conduit box assembly 40. The conduit union 62 may have an annular structure and be configured to enable passage of one or more cables (e.g., the cables 54, 72) and/or conductors (e.g., conductors 81, 83, 85, 87) from the housing 50 of the conduit box assembly 40 into the component 36. The conduit union 62 may connect the housing 50 of the conduit box assembly 40 directly to the component 36 and may be configured to be used in explosive environments, such has Zone 2 and/or T3 areas of the turbine system 10. In certain embodiments, a sealing compound may be provided on a component end 93 of the conduit union 62 to protect from an explosion propagating to the rest of the system 42. In the illustrated embodiment, the conduit union 62 is connected to the housing 50 of the conduit box assembly 40 directly across (e.g., opposite) from the cable gland 56 along the radial axis 102. In some embodiments, one or more conduit unions 62 may be fitted to the housing 50 of the conduit box assembly 40 in a variety of configurations relative to the other connected conduit fittings.

In some embodiments, the drain 60 may be connected to housing 50 of the conduit box assembly 40. The drain 60 may be used to minimize moisture build up within conduit box assembly 40 by allowing the conduit box assembly 40 to breathe with the surrounding atmosphere and enabling moisture present within the housing 50 of the conduit box assembly 40 to drain, while maintaining the integrity of the conduit box assembly 40. The drain 60 may be configured to be explosion-proof (Ex d) rated for use in any Zone 2 and/or T3 area of the turbine system 10. In the illustrated embodiment, one drain 60 is connected to the housing 50 of the conduit box assembly 40 circumferentially 104 between the cable gland 56 and the conduit union 62. In some embodiments, one or more drains 60 may be connected to the housing 50 of the conduit box assembly 40 in a variety of orientations relative to the other conduit fittings connected to conduit box assembly 40.

In some embodiments, the stopper plug 58 may be connected to each of the openings 52 in the housing 50 of conduit box assembly 40 that are not being used for connections to cables or components, for use of a drain, or for connection of any other conduit fitting. In some embodiments, the stopper plug 58 may have a solid cylindrical structure and may be configured of explosion-proof (Ex d) material to maintain the integrity of a conduit box assembly 40 for use in a Zone 2 and/or T3 area of the turbine system 10. In the illustrated embodiment, one stopper plug 58 is positioned circumferentially between the cable gland 56 and the conduit union 62. In some embodiments, one or more stopper plugs 58 may be connected to the housing 50 of the conduit box assembly 40 at any unused openings 52. The stopper plugs 58 may be positioned on the housing 50 of the conduit box assembly 40 in a variety of configurations relative to the other connected conduit fittings.

The embodiment illustrated in FIG. 5 shows the various conduit fittings (e.g., the cable glands 56, 70, the drain 60, the stopper plug 58, the conduit union 62) connected to the conduit box assembly 40 in a specific orientation. In some other embodiments, the conduit fittings may be oriented in a variety of configurations. The individual conduit fittings, housing 50, and cables used may be configured to be explosion-proof (Ex d) rated and/or configured for use in Zone 2 and/or T3 areas, enabling the entire conduit box assembly 40 to be an explosion-proof enclosure rated for use in any Zone 2 and/or T3 area of the turbine system 10.

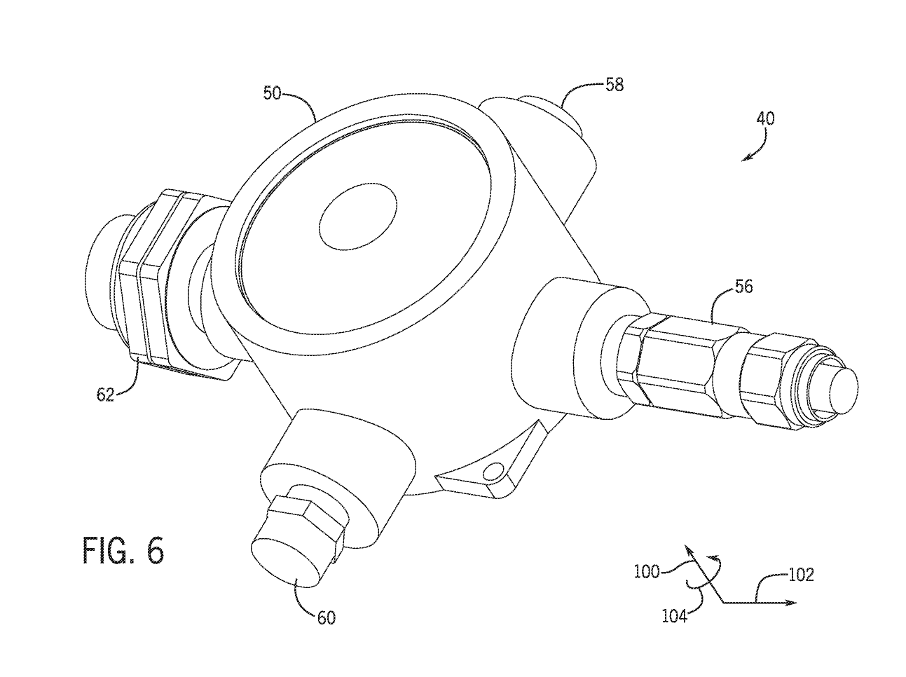

FIG. 6 illustrates a perspective view of the embodiment of the conduit box assembly 40 shown in FIG. 5. As in FIG. 5, FIG. 6 illustrates an embodiment with one cable gland 56, one conduit union 62, one drain 60, and one stopper plug 58 all positioned circumferentially 104 around the housing 50. In some embodiments, there may be one or more of each conduit fitting that is present in a particular embodiment, and the conduit fittings may be oriented in a variety of configurations relative to one another. The housing 50 of conduit box assembly 40 and the individual conduit fittings connected in a particular embodiment may be configured to be explosion-proof (Ex d) rated for use in Zone 2 and/or T3 areas of turbine system 10, enabling the entire conduit box assembly 40 to be rated for use in any Zone 2/T3 area of the turbine system 10.

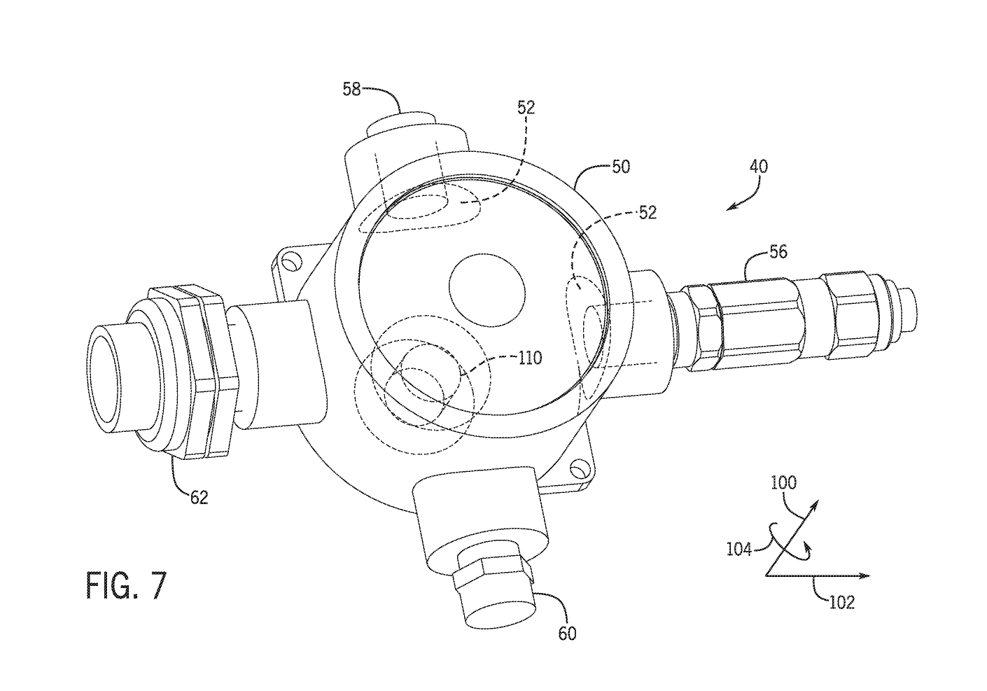

FIG. 7 illustrates a cross-sectional perspective view of the embodiment of the conduit box assembly 40 shown in FIGS. 5 and 6. FIG. 7 illustrates the multiple openings 52 in the housing 50 of the conduit box assembly 40. In some embodiments, one or more of the openings 52 may be threaded openings to enable connection with any conduit fittings, such as cable glands, conduit unions, drains, and stopper plugs, for example. In the illustrated embodiment, the multiple openings 52 in the housing 50 are arranged circumferentially 104 around the conduit box assembly 40. In some embodiments, the arrangement of the openings 52 may be in a variety of configurations and be connected to a variety of combinations of conduit fittings (e.g., the cable glands 56, 70, the drain 60, the stopper plug 58, the conduit union 62). The conduit fittings connected to the housing 50 may include one or more cable glands for connection of cables to the conduit box assembly 40, and connection to an electrical device (e.g., the electrical device 64) housed inside the housing 50 of the conduit box assembly 40. In some embodiments, the conduit box assembly 40 may provide a seat 110 (e.g., mount or support structure) for supporting the cables and/or the electrical device within the housing 50. The conduit box assembly 40 may be configured to be an explosion-proof (Ex d) enclosure and/or configured for use in a Zone 2 and/or T3 area of the turbine system 10, with the housing 50 and each of the conduit fittings being configured for use in such areas.

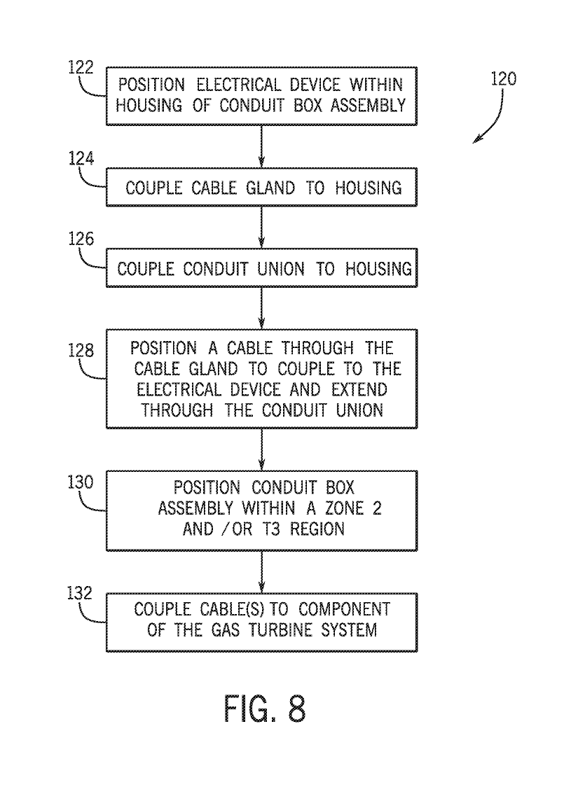

FIG. 8 is a flow diagram of a method 120 of assembling an embodiment of the system 42 of FIG. 1 and for coupling an electrical device (e.g., the electrical device 64) to a component (e.g., the component 36), which may be located in a Zone 2 and/or T3 area of the turbine system 10 using a conduit box assembly (e.g., the conduit box assembly 40). In some embodiments, the method 120 may include positioning the electrical device, such as a varistor or a resistor, within the housing (e.g., the housing 50) of the conduit box assembly (block 122). The housing may be rated for use in various chemical and/or thermal environments, including a Zone 2 and/or T3 area of a gas turbine system, and/or may provide an explosion-proof (Ex d) rated enclosure. In some embodiments, the electrical device may be supported by a seat (e.g., the seat 110) within the housing of the conduit box assembly.

One or more cable glands (e.g., cable glands 56, 70) may be connected to the multiple openings (e.g., openings 52) in the housing of the conduit box assembly (block 124). The one or more cable glands may be connected at any of the openings in the housing of the conduit box assembly. One or more conduit unions (e.g., conduit union 62) may be connected to the housing of the conduit box assembly (block 126). The one or more conduit unions may be connected at any of the openings in the housing of the conduit box assembly. One or more cables (e.g., cables 54, 72) may be positioned through the one or more cable glands to couple to the electrical device housed inside of the conduit box assembly, and the one or more cables may be extended through the conduit union (block 128). The conduit union may be configured to enable passage of multiple cables and/or conductors. Any other openings in the housing of the conduit box assembly may be connected to a drain (e.g., drain 60), a stopper plug (e.g., stopper plug 58), or any other conduit fitting as needed based on orientation and use of the conduit box assembly in system 42. In some embodiments, the conduit box assembly may be positioned within a Zone 2 and/or T3 area of the gas turbine system adjacent to the component of the turbine system to which it is configured to be coupled (block 130). The one or more cables extending through the housing of the conduit box assembly and the conduit union may be coupled to a component of the turbine system within the Zone 2 and/or T3 area (block 132).

Technical effects of the disclosed embodiments include facilitating the positioning and connection of an electrical device that may not be rated for use in a hazardous area, such as a varistor or a resistor, to a component in various chemical and thermal environments of a gas turbine system, including Zone 2 and/or T3 rated areas. The conduit box assembly is configured to enable the installation of a variety of electrical devices next to the components of the gas turbine system to which they are configured to be coupled. An explosion-proof (Ex d) rated conduit box assembly enables installation of an electrical device directly next to the component it is configured to protect, providing better protection by the electrical device and/or saving space in remote electrical cabinets. Moreover, use of the conduit box assembly may adjust the cables about the gas turbine system and may simplify servicing and access to components of the gas turbine system.

This written description uses examples to disclose the concepts discussed herein, including the best mode, and also sufficient disclosure to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a conduit box assembly configured to be rated as an explosion-proof (Ex d) rated enclosure, comprising:
a housing configured to support an electrical device, wherein the housing comprises a plurality of openings;
a first cable gland positioned at a first opening of the plurality of openings to enable a cable to extend into the housing to the electrical device; and
a conduit union positioned at a second opening of the plurality of openings and configured to couple to a component of a gas turbine system, wherein the conduit union enables the cable to extend from the electrical device out of the housing to couple to the component.

2. The system of claim 1, wherein the conduit box assembly comprises a drain positioned at a third opening of the plurality of openings.

3. The system of claim 1, wherein the electrical device is not rated for a Zone 2 region of the gas turbine system, and the conduit box assembly is configured to be located in the Zone 2 region of the gas turbine system.

4. The system of claim 1, wherein the conduit box assembly is configured to be located in a T3 temperature class region of the gas turbine system.

5. The system of claim 1, wherein the conduit box assembly comprises a stopper plug positioned at a third opening of the plurality of openings.

6. The system of claim 1, wherein the conduit box assembly comprises a second cable gland positioned at a third opening of the plurality of openings.

7. The system of claim 6, wherein the first cable gland and the second cable gland each enable separate cables to extend into the housing, and wherein the conduit union enables multiple cables to extend out of the housing to couple to the component.

8. The system of claim 1, comprising the component of the gas turbine engine, wherein the component is a solenoid valve.

9. A system, comprising:
a component of a gas turbine system;
a conduit box assembly, comprising:
a housing;
an electrical device positioned within the housing;
a first cable gland positioned at a first opening formed in the housing; and
a conduit union positioned at a second opening formed in the housing, wherein the conduit union is configured to couple to and to contact the component; and
a first cable extending through the first cable gland into the housing to couple to the electrical device and extending from the housing through the conduit union to couple to the component.

10. The system of claim 9, wherein the electrical device is a varistor or a resistor.

11. The system of claim 9, wherein the conduit box assembly comprises a drain positioned at a third opening formed in the housing.

12. The system of claim 9, wherein the conduit box assembly is configured to be located in a Zone 2 region of the gas turbine system.

13. The system of claim 9, wherein the conduit box assembly is configured to be located in a T3 temperature class region of the gas turbine system.

14. The system of claim 9, wherein the conduit box assembly is configured to be an explosion-proof (Ex d) rated enclosure.

15. The system of claim 9, wherein the conduit box assembly comprises a stopper plug positioned at a third opening formed in the housing.

16. The system of claim 9, wherein the conduit box assembly comprises a second cable gland positioned at a third opening formed in the housing.

17. The system of claim 16, comprising a second cable extending through the second cable gland into the housing and extending from the housing through the conduit union to couple to the component.

18. The system of claim 9, wherein the component is a solenoid valve.

19. A method, comprising:
positioning an electrical device within a housing of a conduit box assembly;
coupling a cable gland to the housing at a first opening in the housing;
coupling a conduit union to the housing at a second opening in the housing;
positioning a cable through the cable gland to couple to the electrical device and extending the cable through the conduit union; and
positioning the conduit box assembly within a Zone 2 region, a T3 region, or a region that is both a Zone 2 and a T3 region of a gas turbine system.

20. The method of claim 19, comprising coupling the conduit box assembly to a component of the gas turbine engine system using the cable extending through the conduit union.
